(19) United States
(12) Patent Application Publication
(10) Pub. No.: US 2007/0185774 A1
(43) Pub. Date: Aug. 9, 2007

(54) Auctioning with bid terminals

(76) Inventors: Caribe C. Schreiber, Saint Paul, MN (US); Daniel P. Kelly, New Brighton, MN (US)

Correspondence Address: Brooks & Cameron, PLLC, Suite 500, 1221 Nicollet Avenue, Minneapolis, MN, 55403, US

(21) Appl. No.: 11/337,141

(22) Filed: Jan. 20, 2006

(51) Int. Cl. G06Q 30/00

(52) U.S. Cl. 705/26

(57) ABSTRACT

Methods and systems are provided for use in auctioning with bid terminals. A first method embodiment includes associating a number of stationary bid terminals with a number of auction items so that each stationary bid terminal is associated with no more than one auction item. The first method also includes receiving a bid, for the particular auction item, through the particular stationary bid terminal.

### BACKGROUND

In the field of auctions, there are many types of auctions with many variations in the number of people participating, the number of items for bid, and the timing that each person can bid on each of the items. At an auction, auction items are offered for sale. Auction participants can submit bids for the auction items. Each auction item is typically sold for a highest bid.

One type of auction is a silent auction, at which auction participants can submit non-verbal bids for auction items. A number of auction items can be simultaneously offered for sale at a silent auction. A silent auction can be a social occasion and can be used as a fundraising activity, where the proceeds of the sales of the auctioned items, or a portion thereof, can be given to a charity. As a result, it can be useful for a silent auction to provide an enjoyable auction experience for auction participants and to encourage them to submit bids for auction items.

One approach to silent auctions includes the use of centralized bid computers for the submission of bids by auction participants. Such an approach typically includes an auction area with a number of auction item displays and a lesser number of centralized bid computers. Each of these centralized bid computers typically includes a monitor, a keyboard, a mouse, and auction software. In this approach, auction participants can use the auction software on the centralized bid computers to submit electronic bids for auction items.

In some situations, this use of centralized bid computers can discourage the submission of bids by auction participants who are uncomfortable using computers. Centralized bid computers also direct auction participants away from an auction item display to submit bids, which can also discourage the submission of bids and make the auction experience less enjoyable. Additionally, in some situations, auction participants may have to wait in long lines to submit bids at the centralized bid computers, which can also make the auction experience less enjoyable.

### BRIEF DESCRIPTION OF THE DRAWINGS

FIG. 1 illustrates an embodiment of an auction system according to the present disclosure.

FIG. 2 illustrates an embodiment of a stationary bid terminal according to the present disclosure.

FIG. 3 illustrates an embodiment of a portable bid terminal according to the present disclosure.

FIG. 4 illustrates a method of auctioning according to the present disclosure.

FIG. 5 illustrates another method of auctioning according to the present disclosure.

### DETAILED DESCRIPTION

The present disclosure includes method and system embodiments for use in auctioning with bid terminals. For example, a method embodiment includes associating a number of stationary bid terminals with a number of auction items so that each stationary bid terminal is associated with no more than one auction item. The method also includes receiving a bid, for the particular auction item, through the particular stationary bid terminal.

An auction provider can use embodiments of the present disclosure to provide an enjoyable auction experience for auction participants and to encourage them to submit bids for auction items. For example, a silent auction can use embodiments of bid terminals of the present disclosure for the submission of electronic bids by auction participants.

Such embodiments can encourage the submission of bids by auction participants who are uncomfortable using computers. Embodiments using bid terminals can allow auction participants to submit bids from various locations, such as near to an auction item display, which can also encourage the submission of bids and make the auction experience more enjoyable. The use of such embodiments can reduce and/or eliminate lines of auction participants waiting to submit bids, which can also make the auction experience more enjoyable.

Some embodiments can allow auction participants to roam around the auction area, or in some embodiments outside the auction area, and monitor their bids on items. Embodiments can allow a participant to enter a maximum bid threshold.

In this way, the participant can start at a low bid and the auction system can submit higher bids for the participant up to the threshold as other bidders make bids that are above the participant's first bid and the maximum threshold. In some such embodiments, the participant can be notified that someone their threshold has been reached, or that someone has bid beyond their threshold, and that they may have to submit a new bid and/or new bid threshold.

Embodiments of the present disclosure and features thereof can be performed by software, firmware, hardware, application modules, and the like. These embodiments can use executable instructions resident on and/or executable by ASICs, devices, systems, or networks shown herein or otherwise. The embodiments of the present disclosure are not limited to any particular operating environment or to instructions written in any particular programming language. Software, firmware, and/or processing modules, suitable for carrying out embodiments of the present disclosure, can be resident on one or more devices in one or more locations.

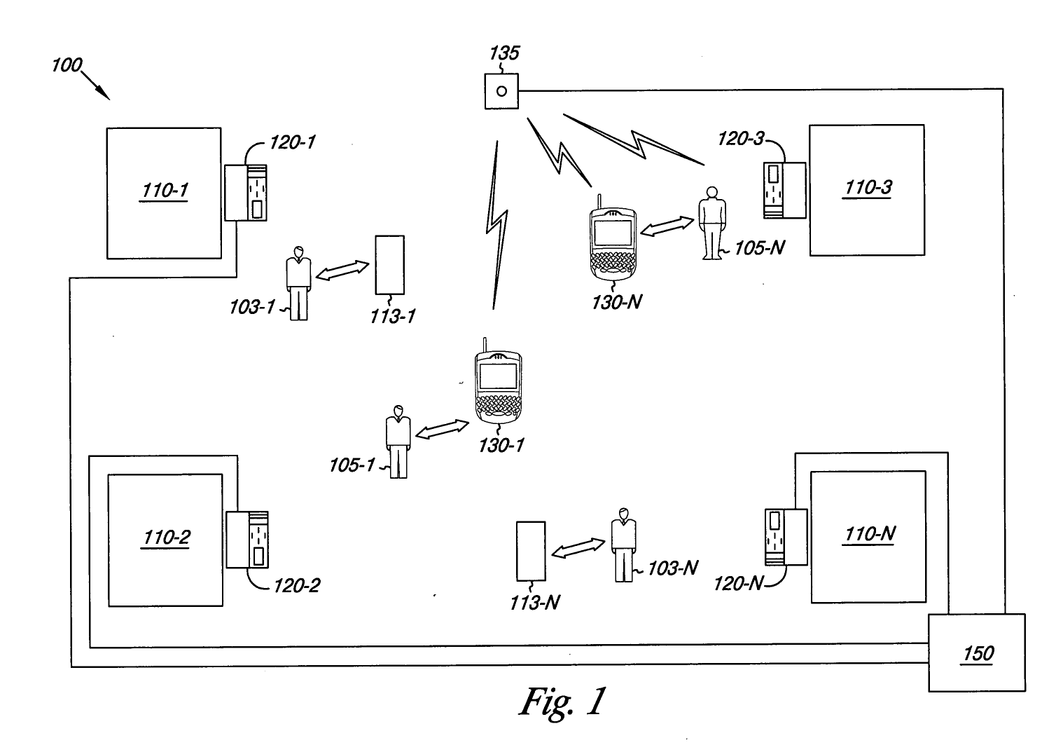

FIG. 1 illustrates an embodiment of an auction system 100 according to the present disclosure. FIG. 1 includes auction participants 103-1 through 103-N and auction participants 105-1 through 105-N. The auction system 100 of the embodiment illustrated in FIG. 1 also includes, auction item displays 110-1, 110-2, 110-3, through 110-N, identifying tokens 113-1 through 113-N, stationary bid terminals 120-1, 120-2, 120-3, through 120-N, portable bid terminals 130-1 through 130-N, an access point 135, and a computing device 150. In the labeling of FIG. 1, “N” can represent any number of items for each item it is used with. Accordingly, the system can, for example, have three items 110, two items 120, and six items 113.

The auction participants 103-1 through 103-N and 105-1 through 105-N participate in the auction. Any of the auction participants 103-1 through 103-N and 105-1 through 105-N can submit one or more bids for auction items offered for sale at the auction. However, an auction participant need not submit a bid, in order to be considered a participant in the auction. An auction participant can be an individual participating on his own behalf, on behalf of one or more individuals, and/or on behalf of one or more entities (e.g. an organization, a corporation, etc.) and may participate without making a bid.

The participation of each auction participant is associated with an auction account. Each auction account is associated with the one or more individuals and/or entities, on whose behalf, the auction participant participates. For example, an auction participant, Joe Smith, may participate in an auction on behalf of ABC Corporation. Joe Smith may be associated with auction account 123. Auction account 123 may be associated with ABC Corporation. Thus, Joe Smith's participation in the auction, such as placing a bid, is associated with auction account 123, which is, in turn, associated with ABC Corporation. In this way, an auction can properly coordinate bidding, bids, and payments for bids, as will be understood by one of ordinary skill in the art.

In the embodiment of FIG. 1, the auction participants 103-1 through 103-N and 105-1 through 105-N can obtain information about the auction items from the auction item displays 110-1 through 110-N. The auction item displays 110-1 through 110-N can include information about the auction items being offered for sale at the auction. In the embodiment of FIG. 1, each auction item display corresponds with an auction item. In this way, the auction participant can enter a bid while reviewing the item.

An auction item display can include its corresponding auction item and/or information about that auction item. For example, an auction item display can simply include its corresponding auction item. Also as an example, an auction item display can include a picture and/or a description of its corresponding auction item, instead of the auction item. As a further example, an auction item display can be information provided through a communication component of a bid terminal, as described below. An auction item can be anything that can be offered for sale at an auction.

In various embodiments, the auction providers (e.g., the entity running the auction) can provide identifying tokens to some or all of the auction participants. In the embodiment of FIG. 1, each of the auction participants 103-1 through 103-N is provided with a particular identifying token, which is, in turn, associated with a particular auction account. For instance, auction participant 103-1 is provided with identifying token 113-1 and auction participant 103-N is provided with identifying token 113-N.

The association between auction accounts and identifying tokens can be accomplished in various ways. For example, a registration process can be used to accomplish this association, in which the association between each auction account and each identifying token can be recorded.

These recorded associations can be stored in various ways. For example, a unique identifier, such as a number, for an auction account, can be associated with another unique identifier, such as a bar-code, for an identifying token. This association between the number and the bar-code can be stored in a database, such as a database in the computing device 150. In various embodiments of the present disclosure, the auction participants 105-1 through 105-N may or may not be provided with identifying tokens.

In embodiments of the present disclosure, various identifying tokens can be used. For example, identification cards, such as bar-code cards, magnetic stripe cards, microchip cards, proximity cards, radio frequency (RF) cards, Wiegand cards, etc., can be used as identifying tokens. Also as an example, auction participants can provide their own identification cards, such as credit cards, driver's licenses, etc., for use as identifying tokens at the auction. Besides identifying tokens, auction accounts can be identified in additional or alternate ways, such as identification with personal identification numbers (PINs), biometrics, etc.

In the embodiment of FIG. 1, stationary bid terminals 120-1 through 120-N are associated with the auction items of the auction item displays 110-1 through 110-N. Each of the stationary bid terminals 120-1 through 120-N is associated with no more than one auction item. In various embodiments, “one auction item” can include multiple identical items offered for sale at an auction. For example, an auction can offer for sale five identical picture frames, which, together, can be considered as one auction item. In this example, one stationary bid terminal can be associated with the five identical picture frames. Alternatively, the auction can include five identical items and the top five bidders will each receive one of the items.

The stationary bid terminal 120-1, in the embodiment of FIG. 1, is associated with an auction item of the auction item display 110-1. In such an embodiment, the stationary bid terminal 120-2 is associated with an auction item of the auction item display 110-2. The stationary bid terminals 120-3 and 120-N are similarly associated with auction items of the auction item displays 110-3 and 110-N, in the embodiment of FIG. 1.

This association between stationary bid terminals and auction items can be accomplished in various ways. For example, a set-up process can be used to accomplish this association, in which an association between each stationary bid terminal and each auction item can be recorded.

These associations can be made in various ways. For example, a unique identifier, such as a bar-code, for a stationary bid terminal can be associated with another unique identifier, such as another bar-code, for an auction item. The association between these two bar-codes can be stored in a database, such as a database on the computing device 150. In various embodiments, a unique identifier for each stationary bid terminal can be associated with a unique identifier for an auction item with which each stationary bid terminal is associated.

In some auction systems, each of the stationary bid terminals 120-1 through 120-N can be physically positioned to correlate with the auction item display for the auction item with which each stationary bid terminal is associated. For example, since the stationary bid terminal 120-1 is to be associated with an auction item of the auction item display 110-1, the stationary bid terminal 120-1 can be physically positioned to correlate with the auction item display 110-1.

Similiarly, the stationary bid terminal 120-2 associated with an auction item of the auction item display 110-2 can be physically positioned to correlate with the auction item display 110-2. The stationary bid terminals 120-3 and 120-N can be similarly physically positioned to correlate with the auction item displays 110-3 and 110-N.

In embodiments of the present disclosure, stationary bid terminals can be physically positioned to correlate with auction item displays in various ways. For example, a stationary bid terminal can be physically positioned near to an auction item display to visually correlate with the auction item display.

In the embodiment of FIG. 1, the stationary bid terminals are illustrated as physically positioned near to and in front of the auction item displays. However, in various embodiments, a stationary bid terminal can be physically positioned to correlate with auction item displays in various other ways, such as being physically positioned beside, beneath, behind, or within an auction item display.

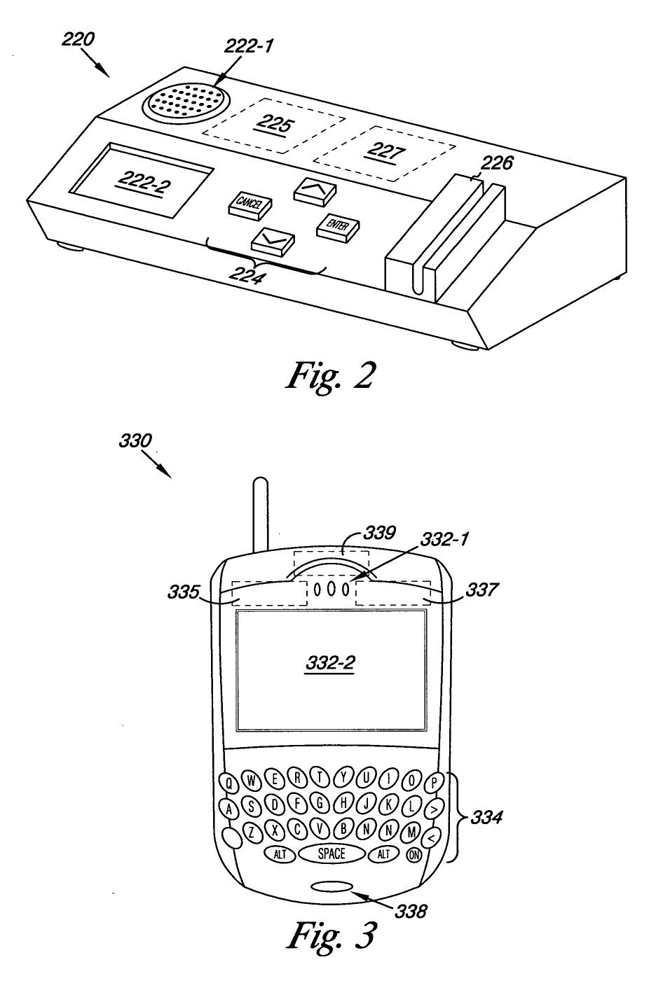

In the embodiment of FIG. 1, each of the stationary bid terminals 120-1 through 120-N can include a communication component, an identification component, and an input component. A communication component included in a stationary bid terminal can be configured to communicate information, such as a bid status for an auction item or auction information, to an auction participant. An identification component included in a stationary bid terminal can be configured to identify an identifying token. An input component included in a stationary bid terminal can be configured to receive information, such as a bid for an auction item, from an auction participant. In various embodiments of the present disclosure, each of the stationary bid terminals 120-1 through 120-N can be a stationary bid terminal as described in connection with FIG. 2.

Each of the stationary bid terminals 120-1 through 120-N is in communication with the computing device 150. This communication can be one or more forms of wired communication, using one or more types of cable, such as FireWire, parallel, serial, twisted pair, USB, etc. and one or more open and/or proprietary communication protocols. In the embodiment of FIG. 1, the stationary bid terminals 120-1, 120-2, and 120-N are in wired communication with the computing device 150. Alternatively, this communication can be one or more forms of wireless communication, such as Bluetooth, cellular, IEEE 802.11, RF, WiFi, Infrared, etc. In the embodiment of FIG. 1, the stationary bid terminal 120-3 is in wireless communication with the computing device 150 through the access point 135. Each of the stationary bid terminals 120-1 through 120-N can transmit information to the computing device 150 and can receive information from the computing device 150.

In various embodiments, the auction provider can provide portable bid terminals to some or all of the auction participants. In the embodiment of FIG. 1, the portable bid terminal 130-1 is provided to the auction participant 105-1 and the portable bid terminal 130-N is provided to the auction participant 105-N.

In the embodiment illustrated in FIG. 1, each of the portable bid terminals 130-1 through 130-N is associated with no more than one auction account. As described above, an auction participant can participate on his own behalf and/or on behalf of others. Associations between portable bid terminals and auction accounts can be accomplished in various ways, such as a registration process, as described above. Associations can also be recorded and stored in various ways, such as in a database on the computing device 150.

In the embodiment of FIG. 1, each of the portable bid terminals 130-1 through 130-N can include a communication component, an input component, and a transceiver component. A communication component can be configured to communicate information, such as a bid status or auction information, to an auction participant. An input component can be configured to receive information, such as a bid for an auction item, from an auction participant. A transceiver component can be configured to transmit information to and receive information from a computing device. In various embodiments of the present disclosure, each of the portable bid terminals 130-1 through 130-N can be a portable bid terminal as described in connection with FIG. 3.

Each of the portable bid terminals 130-1 through 130-N is in communication with the computing device 150 through the access point 135. This communication can be wired and/or wireless communication in various embodiments. And, the communication can be provided by one or more of various open and/or proprietary protocols, such as Bluetooth, cellular, IEEE 802.11, RF, WiFi, Infrared, etc. Each of the portable bid terminals 130-1 through 130-N can transmit information to the computing device 150 and can receive information from the computing device 150 through the access point 135. As a result, each of the portable bid terminals 130-1 through 130-N can be physically positioned remote from the computing device 150, yet each can maintain communication with the computing device 150.

The computing device 150 can be a computing device of various types. The computing device 150 can include a number of processors, memory, storage devices, and communication connections. The memory and/or the storage devices can be used to store an operating system, auction software, and/or information in a database, among other uses. The processor(s) can be associated with the memory, the storage devices, and/or the communication connections. In various embodiments of the present disclosure, the memory and the processor(s) can be integrated together as a single device. The processor(s) can use information stored in the memory and/or the storage devices to accomplish various tasks of the auction system. The processor(s) can also execute instructions, such as those in the operating system and/or the auction software. Processor(s) can also transmit and/or receive information through the communication connections, in some embodiments.

The computing device 150 can be in communication with the stationary bid terminals 120-1 through 120-N, as described above, through the communication connections of the computing device 150. The computing device 150 can receive information from and transmit information to each of the stationary bid terminals 120-1 through 120-N. The communication between the computing device 150 and the stationary bid terminals 120-1 through 120-N can be wired communication and/or wireless communication.

The computing device 150 can also be in communication with the portable bid terminals 130-1 through 130-N through the access point 135, as described above, and through the communication connections of the computing device 150. The computing device 150 can receive information from and transmit information to each of the portable bid terminals 130-1 through 130-N. In the embodiment of FIG. 1, the communication between the computing device 150 and the portable bid terminals 130-1 through 130-N is illustrated as wireless communication.

In various embodiments, the computing device 150 can communicate with the stationary bid terminals 120-1 through 120-N and/or the portable bid terminals 130-1 through 130-N via one or more networks. For example, the network can be a computer network, such as a local-area-network (e.g. Ethernet) or a wide-area-network. Also as an example, the network can be a communication network, such as a cellular communication network or the Internet. Such computer and communication networks can be public or private (e.g. an ATM network) and can use various open and/or proprietary communication protocols.

If a database is utilized, the database can store information about various associations. For example, the database can store information about associations between the stationary bid terminals 120-1 through 120-N and auction items, such as those recorded in a set-up process, as described above.

The database can also store information about associations between auction accounts and identifying tokens, such as those recorded in a registration process, as described above. The database can further store information about associations between portable bid terminals and auction accounts, such as those recorded in a registration process, as described above.

In various embodiments of the present disclosure, a number of databases and/or various software can also be used to store information about these associations. The database can also store information received from the auction software in the computing device 150.

The auction software in the computing device 150 can include instructions that can execute to perform various functions for the auction. For instance, instructions can execute to identify an auction account by using an identifying token provided to an auction participant.

In the embodiment illustrated in FIG. 1, for example, the auction participant 103-1 can provide the identifying token 113-1 to the identification component in the stationary bid terminal 120-1. The identification component can transmit information about the identifying token 113-1 to the computing device 150. The computing device can use the associations between auction accounts and identifying tokens in the database to identify an auction account associated with the identifying token 113-1. Instructions can also execute to transmit information about such an identification from the computing device 150 to a bid terminal and/or to the database in the computing device 150.

In various embodiments, instructions can also execute to identify an auction account by using a portable bid terminal provided to an auction participant. For example, in the embodiment of FIG. 1, the portable bid terminal 130-1 can wirelessly transmit information to the computing device 150, which can use the associations between portable bid terminals and auction accounts in the database to identify the auction account associated with the portable bid terminal 130-1. Instructions can also execute to transmit information about such an identification from the computing device 150 to a bid terminal and/or to the database in the computing device 150.

In some embodiments, instructions can execute to receive a bid for an auction item from an auction participant through a bid terminal. For example, in the embodiment illustrated in FIG. 1, an auction participant 103-1 can place a bid by using an input component in the stationary bid terminal 120-1, which can transmit the bid to a computing device 150. In various embodiments, the auction participant 105-1 can place a bid by using the input component in the portable bid terminal 130-1, which can wirelessly transmit the bid to the computing device 150. Instructions can, in some embodiments, execute to transmit such a bid to a database in a computing device 150.

In various embodiments, instructions can execute to determine a bid status for an auction item. A bid status can include various information about bids for an auction item, for example, information about a current leading bid for the auction item, such as the value of the current leading bid, the time the current leading bid was placed, and/or a name of an auction participant who placed the current leading bid. If there are no bids for an auction item, then a bid status can include information about the lack of bids, in some embodiments. Also as an example, a bid status can include information about bids placed for the auction item prior to a placement of a current leading bid, such as information about a bid placed immediately preceding the placement of the current leading bid, a number of bids placed, and/or a number of auction participants who placed bids, among other items.

Instructions can execute to determine a bid status for an auction item in various ways. For example, instructions can execute to determine a bid status for an auction item by using one or more bids received from one or more auction participants through one or more bid terminals. Instructions can also execute to transmit a bid status for an auction item to a bid terminal and/or to the database in the computing device, such as computing device 150 of the embodiment of FIG. 1.

Instructions can execute to determine auction information. Auction information can include various information about the auction, such as a number of auction items offered for sale at the auction, a number of auction items for which no bids have been placed, and/or an amount of time remaining in the auction, among other items. Instructions can also execute to transmit auction information to a bid terminal and/or to the database in the computing device 150.

In various embodiments of the present disclosure, the database and/or one or more of the auction functions described above, can be provided alternatively or additionally in some or all of the stationary bid terminals 120-1 through 120-N and/or in some or all of the portable bid terminals 130-1 through 130-N. Such embodiments can also be used with distributed computing, in which functions of the processor(s) of the computing device 150, described above, can be distributed to some or all of the bid terminals and performed by those terminals, as will be understood by one of ordinary skill in the art.

Stationary and/or portable bid terminals can include a number of components, such as communication components, input components, identification components, processors, and memory, among others. For example, FIG. 2 illustrates an embodiment of a stationary bid terminal 220 according to the present disclosure. The stationary bid terminal 220 includes a first communication component 222-1, a second communication component 222-2, an input component 224, an identification component 226, a processor 225, and a memory 227.

Bid terminals can include a first communication component, such as a speaker configured to communicate information by producing audio information, such as spoken messages. The speaker can be an electromechanical transducer, for example.

Some embodiments can include a second communication component. For instance, the second communication component 222-2, of the embodiment of FIG. 2, is a display configured to communicate information by showing visual information, such as text and/or graphics, such as illustrations or images. Such displays can be configured to show a bid status as text, among other formats.

The display can be of any type, including, for example, a liquid crystal display (LCD), a cathode ray tube (CRT), a light emitting diode (LED), etc. A stationary bid terminal can include these audio and visual communication components and/or one or more other communication components in its design.

In the embodiment of FIG. 2, an input component is provided as a keypad 224 configured to receive a bid from an auction participant by receiving one or more keypad inputs. The keypad 224 of FIG. 2 includes an up key, a down key, a cancel key, and an enter key. However, keypad input components can include various keys, including, for example, a number of alpha and/or numeric keys. A bid terminal can utilize other input components instead of or in addition to a keypad. One such other input component is a touch screen.

In the embodiment of FIG. 2, the identification component 226 is provided as a card-reader configured to identify an identification card by reading the identification card. The card-reader of FIG. 2 can, for example, be a bar-code card reader or other type of card-reader for reading various types of identification cards, including, for example, magnetic stripe cards, microchip cards, proximity cards, RF cards, Wiegand cards, etc. Other identification components can be used in addition to or instead of a card reader. One such other identification component is a biometric identification component.

In various embodiments of a bid terminal, an input component can also be utilized as an identification component. For example, a keypad can be configured to receive keypad inputs for a personal identification code, e.g., a personal identification number (PIN), to identify an auction account and also configured to receive keypad inputs for a bid placed by an auction participant.

In the embodiment of FIG. 2, the stationary bid terminal 220 includes a processor 225, memory 227, and a number of communication connections. The memory 227 can be used to store an operating system and various other programs and/or information.

In various embodiments, the stationary bid terminal 220 can store auction software in the memory 227 which can include executable instructions to perform various functions for the auction. For example, the memory 227 can include executable instructions to perform functions, such as those described in connection with FIG. 1.

In the embodiment of FIG. 2, the processor 225 is connected to the memory 227 and to a number of communication connections. The processor 225 can use information stored in the memory 227 to accomplish auction functions. The processor 225 can also execute instructions, such as those in the operating system. The processor 225 can transmit and receive information through one or more communication connections, to and/or from one or more other devices, such as a computing device.

FIG. 3 illustrates an embodiment of a portable bid terminal 330 according to the present disclosure. The portable bid terminal 330 includes a first communication component 332-1, a second communication component 332-2, an input component 334, a processor 335, a memory 337, a microphone 338, and a wireless transceiver 339.

In the embodiment of FIG. 3, the first communication device 332-1 is a speaker configured to communicate information by producing audio information, such as spoken messages. The input component 334, in the embodiment of FIG. 3, is a keypad configured to receive a bid from an auction participant by receiving one or more keypad inputs. In various bid terminal embodiments, a microphone (e.g., microphone 338) can be an input component.

In the embodiment of FIG. 3, the portable bid terminal 330 includes processor 335, memory 337, and a wireless transceiver 339. The processor 335 can transmit and receive information through the wireless transceiver 339, through an access point to and/or from one or more other devices, such as a computing device.

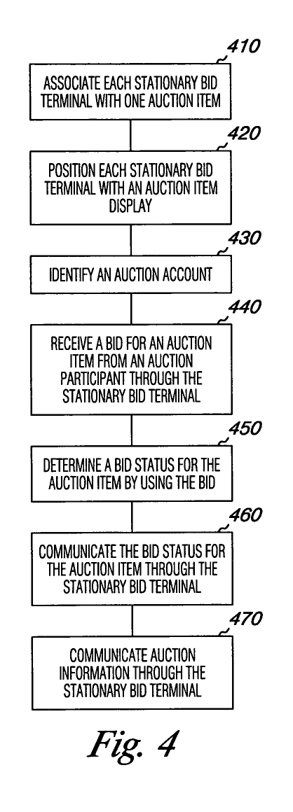

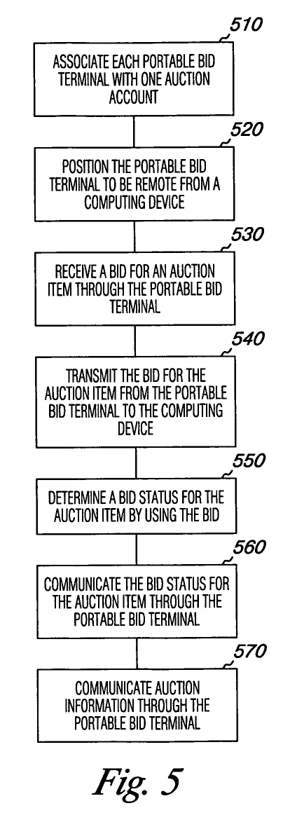

FIGS. 4 and 5 illustrate method embodiments of the present disclosure. Unless explicitly stated, the method embodiments or elements thereof that are described herein are not constrained to a particular order or sequence. Additionally, some of the described method embodiments or elements thereof can occur or be performed at the same point in time.

FIG. 4 illustrates a method of auctioning according to the present disclosure. At block 410, the method of FIG. 4 includes associating each stationary bid terminal, from a number of stationary bid terminals, with one auction item, from a number of auction items offered for sale at the auction.

The method of FIG. 4 also includes, at block 420, physically positioning each stationary bid terminal to correlate with an auction item display for an auction item with which each stationary bid terminal is associated, at block 410. According to block 430, the method of FIG. 4 further includes identifying an auction account by using an identification component in a stationary bid terminal from the number of stationary bid terminals of block 410.

The method of FIG. 4, at block 440, includes receiving a bid from an auction participant for an auction item offered for sale at the auction. This bid is received through the stationary bid terminal of block 430, through which the auction account is identified.

At block 450, the method of FIG. 4 also includes determining a bid status for the auction item for which the bid is received at block 440. This determination of the bid status is made by using the bid received at block 440. In the method of FIG. 4, this bid status is communicated, at block 460, through a communication component in the stationary bid terminal of block 430, through which the auction account is identified. At block 470, the method of FIG. 4 also includes communicating auction information through the communication component in the stationary bid terminal of block 430.

FIG. 5 illustrates another method of auctioning according to the present disclosure. At block 510, the method of FIG. 5 includes associating each portable bid terminal, from a number of portable bid terminals, with one auction account, from a number of auction accounts at the auction.

The method of FIG. 5 also includes, at block 520, physically positioning a portable bid terminal, from the number of portable bid terminals of block 510, to be remote from a computing device. According to block 530, the method of FIG. 5 further includes receiving a bid for an auction item offered for sale at the auction.

This bid is placed through the portable bid terminal of block 510 by an auction participant to whom the portable bid terminal is provided. At block 540, the method of FIG. 5 also includes transmitting the bid, received at block 530, for the auction item, from the portable bid terminal of block 520 to the computing device of block 520.

The method of FIG. 5 further includes, at block 550, determining a bid status for the auction item for which the bid is received at block 530. This determination of the bid status is made by using the bid received at block 530.

In the method of FIG. 5, this bid status is communicated, at block 560, through a communication component in the portable bid terminal of block 520. At block 570, the method of FIG. 5 also includes communicating auction information through the communication component in the portable bid terminal of block 520.

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that embodiments of the present disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method of auctioning comprising:
associating a number of stationary bid terminals with a number of auction items so that each stationary bid terminal is associated with no more than one auction item; and
receiving a bid, for the particular auction item, through the particular stationary bid terminal.

2. The method of claim 1, wherein the method includes communicating a first bid status, for a particular auction item, through a particular stationary bid terminal associated with the particular auction item; and
determining a second bid status, for the particular auction item, by using the first bid status and the bid.

3. The method of claim 2, wherein the method includes communicating the second bid status, for the particular auction item, through the particular stationary bid terminal.

4. The method of claim 1, wherein the method includes physically positioning each stationary bid terminal to correlate with an auction item display for an auction item with which each stationary bid terminal is associated.

5. The method of claim 1, wherein associating includes associating a unique identifier for each stationary bid terminal with a unique identifier for an auction item with which each stationary bid terminal is associated

6. The method of claim 2, wherein communicating includes showing the first bid status on a display of the particular stationary bid terminal.

7. The method of claim 1, wherein receiving includes receiving the bid by using an input component of the particular stationary bid terminal.

8. The method of claim 1, including identifying an auction account associated with the bid by identifying an identifyng token by using an identification device of the particular stationary bid terminal.

9. A method of auctioning comprising:
associating a number of portable bid terminals with a number of auction accounts, so that each portable bid terminal is associated with no more than one auction account;
receiving a first bid for a particular auction item through a first particular portable bid terminal; and
determining a first bid status, for the particular auction item, by using the first bid.

10. The method of claim 9, wherein the method includes communicating the first bid status through the first particular portable bid terminal.

11. The method of claim 9, wherein the method includes communicating auction information about an auction in which the first bid is received, through the first particular portable bid terminal.

12. The method of claim 9, wherein the method includes transmitting the first bid to a database in a computing device that is remote from the first particular portable bid terminal.

13. The method of claim 12, wherein transmitting includes wireless transmitting.

14. The method of claim 9, including:
receiving a second bid for the particular auction item, through a second particular portable bid terminal; and
determining a second bid status, for the particular auction item, by using the second bid.

15. The method of claim 14, including communicating the second bid status through the first particular portable bid terminal.

16. An auction system comprising a number of stationary bid terminals, wherein each stationary bid terminal:
is associated with no more than one auction item;
includes a communication component configured to communicate information to an auction participant;
includes an identification component configured to identify an identifying token; and
includes an input component configured to receive a bid from an auction participant.

17. The system of claim 16, wherein each stationary bid terminal is to be physically positioned to correlate with an auction item display for an auction item with which each stationary bid terminal is associated.

18. The system of claim 17, wherein the communication component is a display configured to communicate information to an auction participant by showing visual information.

19. The system of claim 17, wherein the identification component is a card-reader configured to identify an identification card by reading the identification card.

20. The system of claim 17, wherein the input component is a keypad configured to receive a bid from an auction participant by receiving a keypad input.

21. The system of claim 17, wherein the system includes a portable bid terminal that:
is associated with no more than one auction account;
includes a communication component configured to communicate information to an auction participant; and
includes an input component configured to receive information from an auction participant; and
includes a transceiver configured to transmit information to and receive information from a database in a computing device.

22. The system of claim 21, wherein each portable bid terminal is to be physically positioned remote from the computing device.

23. The system of claim 21, wherein the information is a bid.
